(19) United States
(12) Patent Application Publication
(10) Pub. No.: US 2006/0282340 A1
(43) Pub. Date: Dec. 14, 2006

(54) INVENTORY MANAGEMENT SYSTEM

(76) Inventors: Adam Morand, Vancouver (CA); Jay Brown, Port Coquitlam (CA); Barclay McInnes, Burnaby (CA)

Correspondence Address: VERMETTE & CO., BOX 40, GRANVILLE SQUARE, SUITE 230 - 200 GRANVILLE STREET, VANCOUVER, BC, V6C 1S4, CA

(21) Appl. No.: 10/908,548

(22) Filed: May 16, 2005

(51) Int. Cl. G06Q 10/00

(52) U.S. Cl. 705/28

(57) ABSTRACT

An inventory management and tracking system for tracking items with RFID tags, which includes a business logic rules engine having a plurality of rules which dictate how information is assembled and presented, provides specific dataset definitions which govern import and export of data to disparate systems, and provides an interface to planning applications as well as high end inventory, management and accounting systems. The system also includes a data storage module coupled to said business logic rules engine, a capture module operative to capture information from said RFID tags, a reporting module operative to determine and produce an accurate inventory of said items, and a data transformation interface coupling said business logic rules engine to said data storage, capture and reporting modules.

### FIELD

The present invention relates to an inventory management system that utilizes radio frequency identification tags (RFID) and various readers to scan the tags and store the information from the point of manufacture to delivery to the site with means to determine inventory on hand, to allocate destinations and group items for distribution. The data is stored after delivery to provide an accurate representation of the location and status of items.

### BACKGROUND

Warehouse inventory management systems, which manage all warehouse resources including personnel and equipment, workgroups, inventory and space. Such systems often use bar-code technology to locate, identify and track items in the warehouse. However, warehouse solutions are not applicable in many other situations such as management of pipe for oil pipelines. In the latter case pipe is stored outside subject to the elements including snow and mud. Often bare-code tags are covered in snow or mud or are inaccessible and cannot be read by conventional bar-code readers. Moreover, warehouse inventory management systems do not extend to tracking materials and equipment from the point of manufacture to the storage or warehouse site or from the latter site to the end user. For example, in building oil or gas pipelines, it is important to know the history and characteristics of each length of pipe in the pipeline and exactly where it has been installed in the event there is a pipeline failure.

Most inventory tracking and management systems must be customized to fit a particular user's business. There is no generally applicable system with an architecture that can be applied to a wide variety of inventory management systems.

### SUMMARY OF THE INVENTION

According to the invention there is provided an inventory management and tracking system for tracking items with RFID tags, which includes a business logic rules engine having a plurality of rules which dictate how information is assembled and presented, provides specific dataset definitions which govern import and export of data to disparate systems, and provides an interface to planning applications as well as high end inventory, management and accounting systems. The system also includes a data storage module coupled to said business logic rules engine, a capture module operative to capture information from said RFID tags, a reporting module operative to determine and produce an accurate inventory of said items, and a data transformation interface coupling said business logic rules engine to said data storage, capture and reporting modules.

Advantageously, the business logic rules engine is replaceable.

Preferably the capture module has multiple types of capture software.

The data storage module may be operative to separate data and provide string to numeric abstraction, and fourth level database normalization to provide integer representation of string values.

The data transformation interface may have a document type definition which is custom for each customer and which shapes datasets and governs the import and export of data in an appropriate format

The business logic rules engine configures RFID tags and RFID tag readers and determines rules which govern transfer of information from the RFID tag readers to the data storage module.

The scanned data sent to said system may be tag ID and location ID.

Only interpreted data is stored in said reporting module to provide pre-configured interpretation of integers, which make up a dataset.

There may be included an alternative data storage site to which non-real time data is exported from the data storage module to carry out advanced analysis.

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a schematic diagram showing the inventory management system;

FIG. 2 is a flow diagram for the system;

FIG. 3 shows all of the documents employed in tracking, shipping, scanning and for personnel;

FIG. 4 is another flow diagram of the system showing in detail the function of the configuration agents; and

FIG. 5 is a flow diagram of the transaction path for items;

### DETAILED DESCRIPTION WITH REFERENCE TO THE DRAWINGS

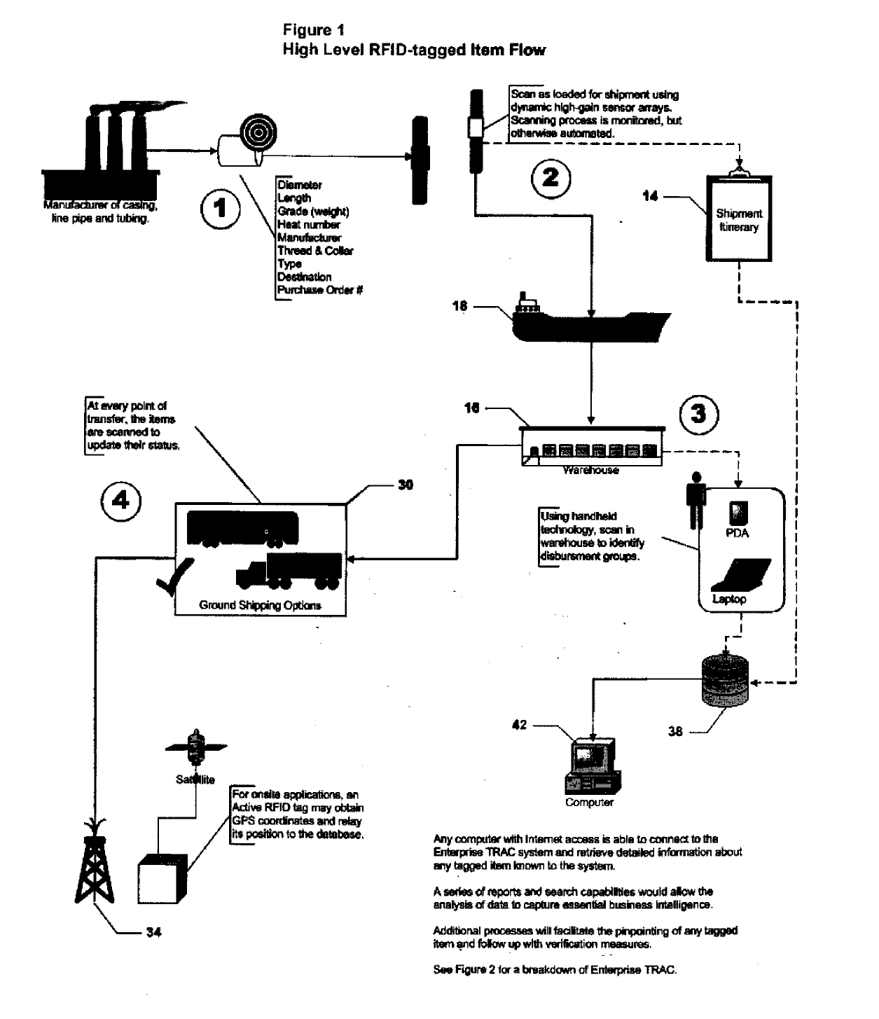

In the following description of a preferred embodiment, application of the system to pipes for the oil pipeline industry will be used as an example. Referring to FIG. 1, at step 1 pipes that have just been manufactured are tagged with RFID tags at the point of manufacture. Each section of pipe would be tagged and the following information related to it placed in the database:
(1) Diameter
(2) Length
(3) Grade (weight)
(4) Heat number
(5) Manufacturer
(6) Thread and Collar Type
(7) Destination
(8) Purchase Order #

These items can then be grouped or otherwise connected by possibly affixing another active RFID tag. At step 2 as the items are loaded onto a container ship 18 for transport, they are scanned by using dynamic high-gain sensor arrays in a process that is monitored by otherwise automatic. The information is stored on the system database for further use.

A shipment itinerary 14 is created and is then related to tracking information provided by the carrier 18. A real time interface with the carrier's system will monitor the exact position of the shipment as it crosses the ocean on its way to delivery. Once the ship 18 has arrived at its destination, at step 3 the shipment is recovered from the carrier ship 18 and placed in a warehouse or storage yard 16. At this point as items arrive handheld RFID scanners/readers and wide area sensors check them to identify disbursement groups. The scanning data is sent to server 38. Ground transportation 30 of various types may be used at step 4 to distribute the items. Given that a transport unit may contain items destined for multiple locations, readings are taken at each stop and the database in server 38 updated. Once items reach a final destination site 34, a reading is taken and the delivery confirmed. Any computer 42 with Internet access is able to connect to the system and retrieve detailed information about any tagged item known to the system.

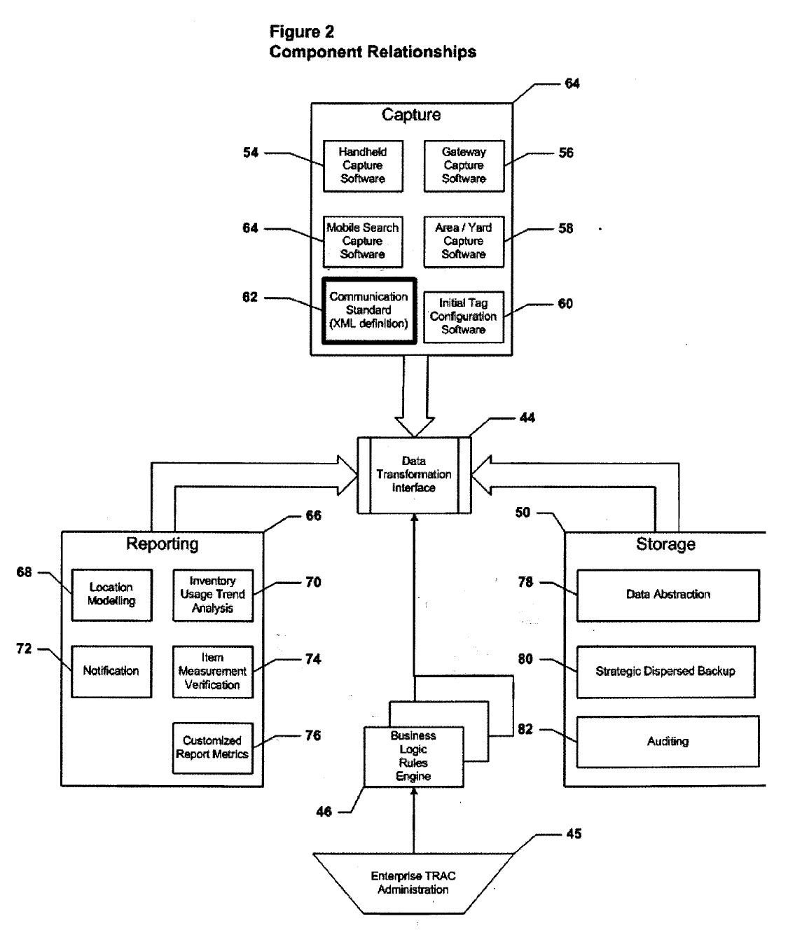

Referring to FIG. 2, the Data Transformation Interface (DTI) 44 acts as the hub for all communication in the system, filtering all communication to ensure data integrity and consistency. The DTI uses information from the Business Logic Rules Engine (BLRE) 46 to present the appropriate interface parameters for each sub-system of the system. The BLRE 46 is the brain of the system and defines the basis for communication throughout all aspects of operation. The DTI is the gateway for all incoming and outgoing data. It performs many functions including the application of the output from the BLRE 46 required for the system and load balancing to effectively distribute traffic during peak periods coming from sources around the world.

Using the DTI will facilitate structured data storage to create an effective data warehouse with superior access capabilities. This addresses the heart of the data storage problem, which plagues RFID implementations today. The typical applications send the complete contents of the RFID tag's information resulting in tremendous duplication of information.

Interoperability

As a system targeted to large-scale operations, the present system has the capability of exchanging data with other Enterprise Resource Planning systems. This data exchange is handled using the standard XML document format and the creation of a custom DTD (Document Type Definition). The DTD is developed as a custom component for each individual customer prior to deploying the system. This ensures the unique requirements of each customer are fully met. Once the DTD is defined, it is used to shape datasets and governs the import and export of data in the appropriate format. It does not require frequent update as it serves as a template for the exchange of information. Using the example dataset presented earlier, the XML format looks as follows:

<pipe handle=“RFID_1234”>

<diameter>20</diameter>
<length>60</length>
<grade>5</grade>
<heatNumber>252</heatNumber>
<manufacturer>14</manufacturer>
<threadCollarType>1</threadCollarType>
<destination>231</destination>

</pipe>

Security

The information exchanged has no meaning without translation tables, which define it. Thus, any information is effectively encoded and useless to an unauthorised reader. It may be further encrypted for additional security in cases where the data is of a sensitive nature.

The functional design of the system is such that the BLRE 46 is replaceable and by simply installing a new component, the system is ready for use by a different organization or even a different industry. The BLRE 46 provides the unique dataset information for each unique application of the system. Every industry shares standard or common data such as customer data, employee data, etc. The BLRE 46 manages the uncommon, proprietary and/or unique datasets required to implement the present system.

The BLRE 46 is a series of “if/else/then” statements, which provide unique rules that dictate how information is assembled and presented. A specific configurable area is for “Notifications” and models a complete hierarchy with appropriate actions.

The BLRE 46 provides the specific dataset definitions, which map to the Storage system 50 where the actual records of data are maintained and managed. These same dataset definitions will govern the import and export of data to disparate systems and provide the essential interface to planning applications as well as high end Inventory and Management and Accounting systems.

Administration of the BLRE has a separate control panel 45 that provides the ability to dynamically view and configure an entire network of RFID-related devices, including the distribution of new business logic or array and capture configurations.

Capture

The system features many different modes of capturing information in its capture module 64. There is handheld tag reader software 54 used on ruggedized PDA's and similar handheld computer devices. This software will read RFID tags and store data for later upload to the system.

The Gateway Pass Through Scan software 56 is designed to support stationary sensor arrays built to be located at entry points to warehouses and similar areas. For example, as a fork lift or truck drives through the Gateway, the RFID tags are scanned as they pass through. This provides a location update without requiring an individual doing a conscious physical scan of the RFID tag. The primary benefit is the reliability of the data and the reduced dependency on human interaction.

The Mobile Search Capture Software 64 uses similar capabilities to the Gateway Pass-Through Scan software except that sensor array is designed to be mounted on the front of a truck. Using high gain arrays, an equipped vehicle may drive around a remote site and detect and capture RFID data. This is extremely useful in field settings where typically there is a covering of snow or mud.

The area/yard Capture Software 46 is designed to facilitate automated data recovery from RFID tags in a given area. At predefined times as well as on demand, the sensor array will scan an entire works yard or warehouse and update the status of all RFID-tagged items found on the premises.

The Initial Tag Configuration Software 60 will accept parameters from the system and encode it to the RFID tube on the screen.

The Communication standard 60 defines the information exchange among different components. Being an XML-based specification, it facilitates information exchange among other third parties.

The Business Logic Rules Engine 46 addresses the Capture process in two distinct ways. First it establishes the configuration of the RFID tags and Readers; and then it determines the rules, which govern the transfer of information from the Reader to the Storage system via the Data Transformation Interface. When an update of the location of the RFID tag is made, there really are only a couple of variables, which are handled, namely, the RFID tag code and the Location ID. The tag reader is connected to a laptop or similar computer system, which manages the data. The laptop is configured with the available locations and when the item is scanned, the data sent to the Enterprise TRAC system consists of only two integers: tag ID and location ID. The other information stored on the RFID tag is already known and does not require update. For infrequent operations, such as mass inventory updates, the RFID reader would submit its data, which is stored on the local system for update as a batch operation. The Business Rules Logic Engine 46 facilitates the definition of activities by defining which require real-time access and which require batch processing. The RFID Reader performs a single function: it reads whatever is on the RFID tag. The transformation occurs by managing that information at the point immediately after the reading and prior to submitting the data to the system.

Reporting

The ultimate goal of the present system is to provide useful and timely data analysis from the acquired data. Reporting is available along two primary metrics:
1. Real-time status reporting; and
2. In-depth analysis.

### a. Real-Time Reporting

Real-time reporting involves a delicate balance between providing the information required in a given context and careful use of network resources. Because the ultimate application environment is in the field, the luxury of high speed connectivity cannot be assumed. Further, the load distribution of thousands of status reports over a widespread area requires that the data packets be comprised of the smallest possible bits of information. An added advantage is that by focusing these reports, the information provided will be tailored to the individual and will contain no extraneous data not immediately relevant. Given these constraints, the emphasis is on defining exactly who needs what information and in what context. Only the data that is required is provided. The interpretation of the data is stored in the report module to provide pre-configured interpretation of the integers which make up the dataset.

b. In-Depth Analysis

Advanced analysis requires greater amounts of information and is not required for day to day operations. The data would be extracted from the Storage component and processed in a dedicated environment. This will provide tremendous depth of information while ensuring the processing of data does not impede the system in its day to day operations.

There are numerous high level reports, which are drawn from the storage system that do not require real-time data. For example, detailed Inventory Usage Trend Analysis is something that would be performed on data from a past period of time. For such demanding analysis, the data is exported from the core Storage system and moved to a separate environment. This preserves the operating capacity of the core system allowing it to optimize data collection and other essential functions. This is known as Data Mining and is a distinct element of the Storage strategy.

The reporting module 66 facilitates the output/reporting of data from the system. The Location Modeling software 68 takes stored data and performs comprehensive analysis guided by the Business Logic Rules Engine 46 to produce an accurate inventory of all tagged items. In systems in which items are scattered across remote locations, such analysis significantly reduces losses and maximizes inventory usefulness.

The Item Usage Trend Analysis software 70 performs analysis with emphasis on which items are reaching their maximum return on investment. Items found to be outside programmed variance amounts may be reallocated. Comparing dates, projects, locations and other factors produces industry-specific reporting influenced by the Business Logic Rules Engine 46.

The Notification software 72 draws settings from the Business Logic Rules Engine 46 and produces customized notifications to email, facsimile, cellphones and pagers as desired. For example, (a) Project Management may require notifiction of deliveries or when a specific item or shipment reaches a specific checkpoint: (b) Regular reminders produce a reliable feedback mechanism to verify a project or shipment is on track; and (c) Notifications may be sent to other systems which facilitate accurate and reliable scheduling.

A sub-component of the Notifications software 72 is Escalate Action Alarms, which is specifically to draw attention to events either happening, or not happening according to criteria set in the Business Logic Rules Engine 46. The alarm process escalates through multiple notification methods and through a series of individuals until corrective action is registered.

The Item Measurement Verification software 74 registers precise calculations of the actual dimensions of specific items to provide real world data useful for planning. For example, a section of pipe may be generally referred to as 10 metres long and a coupling may be 20 cm in length. In a real world application, two sections of pipe joined by a coupling may yield a total of 20.1 m of pipe length.

The Customized Report Metrics 76 provides the means to configure custom reports with the ability to drill down to the specific item level. Examples of the metrics include Capitalization, Useful Life Span, Return On Investment, Cost, Escalation, Pipeline, Shipments Received, Quantity On Hand, Quantity On Order, Forecasts, and Transactions.

Working in combination, the components produce unique and highly useful applications. For example, regular reports run by the Inventory Usage Trend Analysis software 70 triggers Notifications 72 and/or Escalate Alarms based on the criteria stored in the Business Logic Rules Engine 46.

Storage

The environment is structured to accept data definition from the Business Rules Logic Engine. The environment is established and the rules are set. No ongoing operations on the database structure are required in the course of normal operations. Undoubtedly, adjustments and extensions to the data definition will be necessary. Using the data abstraction model, new information requirements are met by adding new tables and associating them with the appropriate dataset without altering any of the existing data structures. This preserves data integrity and provides the flexibility demanded by system users.

The Storage module 50 has Data Abstraction software 78, which separates the data to allow for the maximum number of permutations. For example, original input data may be in a string format but by normalizing it and assigning a numeric value to it, the original input data may be subjected to mathematical algorithms for advanced analysis.

String to numeric abstraction provides a standardized consistent database architecture that allows the application of mathematical formulae to produce visual data as well as facilitating the preparation of application-specific reports translated back to their original string representations.

Fourth level database normalization is used to provide integer representation of string values. The purpose for this is that operating on integers is orders of magnitude faster than string operations. This dramatically expands the operational capacity of the system.

The Strategic Dispersed Backup software 80 follows a systematic process, which ensures multiple backup sources are secure and recoverable. The dispersion methodology preotects the data from unauthorized access because it will require the knowledge of several elements to successfully decrypt the data.

The Auditing software 82 ensures procedures are in place to accurately reflect database activity and conform to even the most demanding audit requirements. Such software is important to the accounting responsibilities of the system tracking millions of dollars of inventory.

RFID Tag Configuration

This specifically addresses what information is actually stored on the tag. The data abstraction model stores the data in concise numeric format for superior data handling performance. This level of configuration determines exactly what data is put onto a tag. The Capture system holds the information required to present real-world definitions in the user interface, then transposes to their numeric representation prior to writing to the tag.

RFID Reader Configuration

The Readers 92 are configured to scan and read the RFID tags 90 and display the real-world information in the capacity available for the specific Reader. In most cases, a local host system is used to gather raw data from the Readers and translate it into real-world data as required for the location. It is left as integer representations for transmission to the system itself.

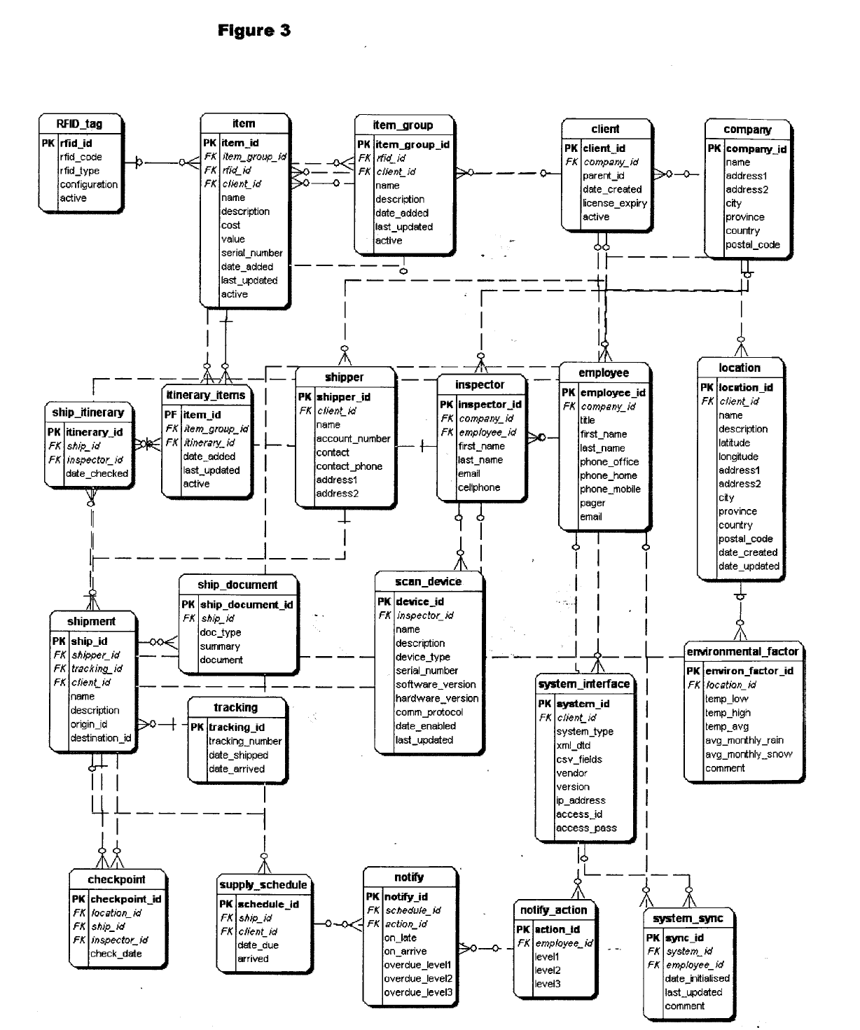

FIG. 3 discloses the various documents that are used in operating the system inventory.

Business Logic Interaction

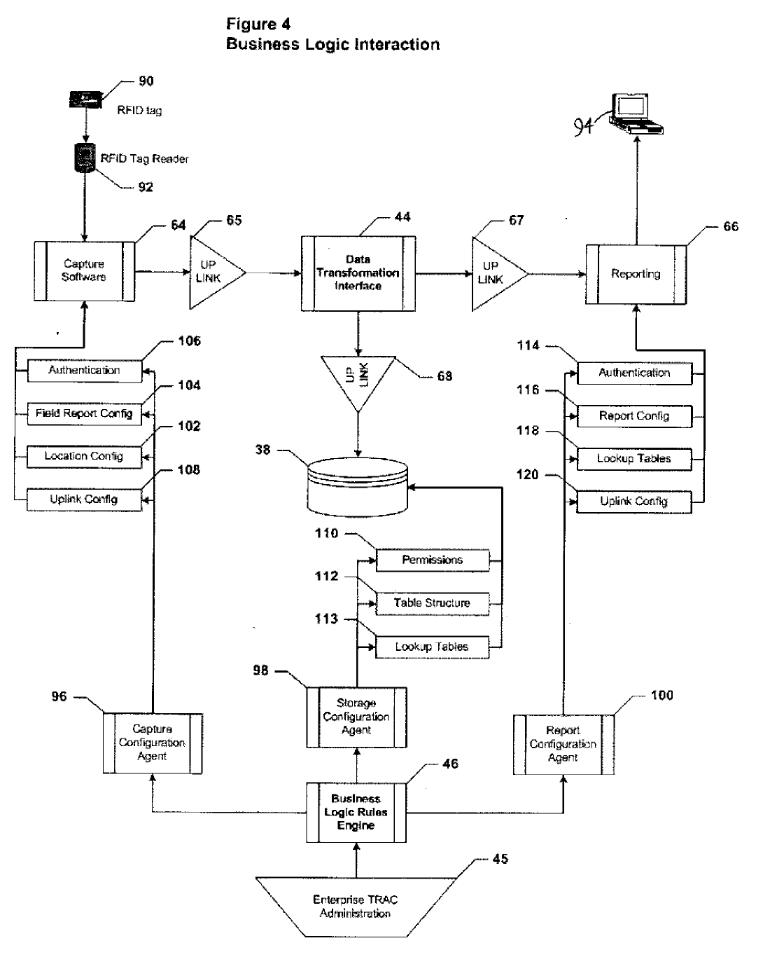

FIG. 4 breaks down the interaction among the Administration Interface 45 and the Capture 64, Storage 50 and Reporting 66 components. The simplified input and output devices are represented as the RFID tag 90, the RFID tag Reader 92 and a computer 94 representing the Reporting environment. This embodies the core functionality of the system whereby information is collected and interpreted. The Administration 45 controls the Business Logic Rules Engine 46. These rules are then carried forward by the Agents responsible for the update of the respective components. The Rules themselves are defined using an intelligent interface designed to capture the business requirements of the organisation. What is passed onto the components is an interpretation of the Rules according to the required functionality for each particular component.

ii. Configuration Agents

The Capture, Storage and Report Configuration Agents 96, 98, and 100 are designed to interpret the business rules and forward the appropriate governing configuration data to their respective input and output devices in the chain.

Capture

The Capture processes are limited and serve to accept data from the Reader device 92 and assemble it on the local computer system. The capture software 64 provides a limited interface to the tag data and prepares the data for transition to the system in Uplink mode.

Authentication

Personnel data is uploaded to the authentification box 106 of the Capture Software 64, which defines who is permitted to use the system and what depth of information and/or actions that person is able to access.

Field Report Configuration

The Field Report Configuration 104 views the data as it comes in and verifies it or makes manual changes to it. The primary information required are the common lookup tables and the report structures.

Location Configuration

The location configuration 102 consists of the primary location codes associated with the capture software 64. Secondary information provides potential sub-locations allowing a warehouse 16 (see FIG. 1) to further specify the physical location of an item within the general facility.

Uplink Configuration

The Uplink Configuration 108 defines the exact format of data to be used when transmitting data up to the system. This provides flexibility in terms of input devices, etc. as well as allowing the data format to change when necessary.

Storage

The definition in the Business Logic Rules Engine 46 governs the storage of data. The definition of the datasets consists of numerous tables where a string representing and describing the element is assigned a unique number. That number, or ID, is used throughout the system to indicate this condition. For example, the material composition of pipe may vary and integer values would be assigned to each description:

| pipe_material_ID | name | Description |
|---|---|---|
| 1 | iron | An iron alloy. |
| 2 | stainless | A stainless steel composite |
| | | which resists rusting. |

The Item Definition table(s) would then refer to the “iron” material type simply as pipe_material_ID=1.

This concept is used throughout and reduces extensive definitions of virtually any type of information to a simple integer. This is an essential aspect of the superior performance characteristics of the present system.

Permissions

The Permissions block 110 is a structured hierarchy which determines the complete authentication structure that governs all access to data. It stems from the Business Rules Logic Engine 46 itself and is consistent across all components.

Table Structure

The Table Structure 112 is the key to interpreting the end data (consisting of integers) and making associations to ultimately reconstruct the data for reporting purposes.

Lookup Tables

The Lookup Tables 113 are derived from the Table Structure 112 and represent individual lookups required to interpret specific data. This is used to provide contextual information for both the Capture 64 and the Reporting 66 components.

Reports

The configuration of a remote system for use as a Reporting environment is as simple as installing the local reporting software 66 then retrieving the Report characteristics from the main system data repository.

Authentication

In the Authentication block 114, personnel data is uploaded to the Capture system, which defines who is permitted to use the system and what depth of information and/or actions that person is able to access.

Report Configuration

The Configuration Reports 116 are focused on the In-Depth Analysis type of reports. The data is moved to a separate environment to assure ongoing stability in the core system. Data analysis can be as intensive as desired because the data is historic. For example, the high level reports concerning Inventory Usage are typically run on quarterly data for closed periods.

Lookup Tables

These lookup tables 118 are required to interpret the numeric representations in the reports.

Uplink Configuration

This defines the exact format of data to be used when transmitting data from the present system. An important aspect of this is a translation module, which will convert data into XML and other standard formats.

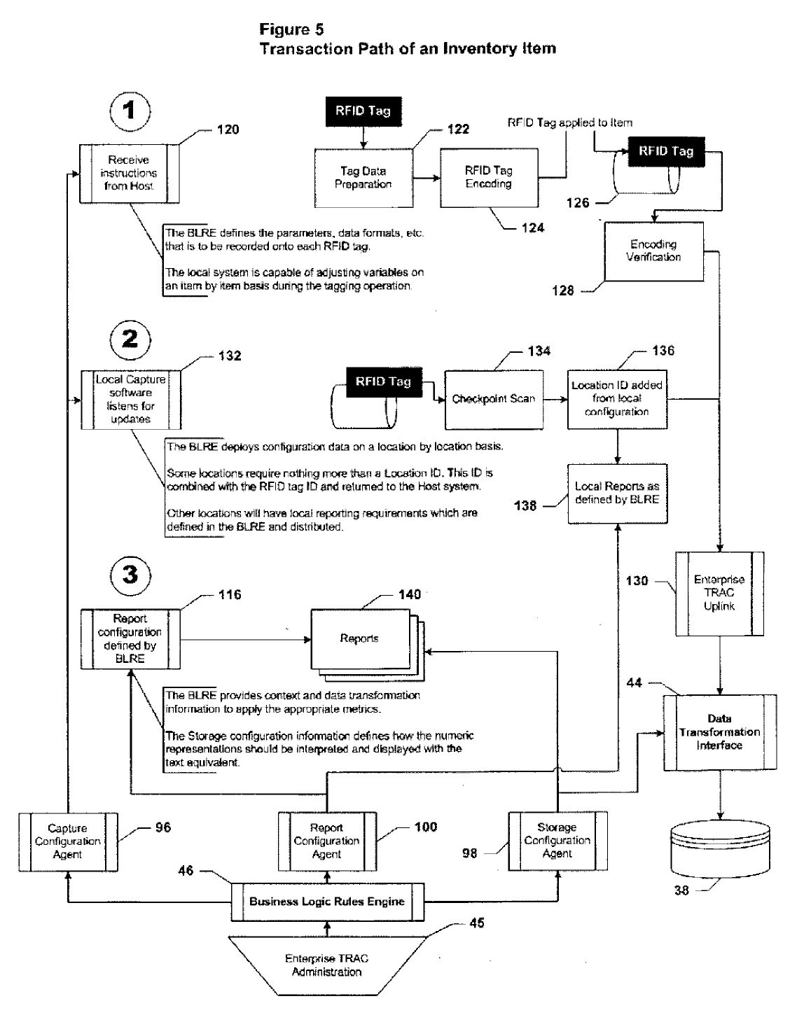

Referring to FIG. 5 at block 120, instructions are received from the BLRE 46 which defines the parameters, data formats, etc. that are to be recorded onto each RFID tag. The local system is capable of adjusting variables on an item by item basis during the tagging operation. Data is prepared at block 122 and the tag is encoded at block 124. At block 126 an RFID is applied to the item and encoding verified at block 128. The encoded data is sent to the Uplink 130 and on to the Data Transformation Interface (DTI) 44 which interfaces with the server 38.

At block 132 the BLRE 46 deploys configuration data on a location by location basis. Some locations require nothing more than a Location ID. This ID is combined with the RFID tag ID and returned to the Host system. Other locations will have local reporting requirements which are defined in the BLRE and distributed. Thus, at block 134 the RFID tag undergoes a checkpoint scan and at block 136 Location ID is added from the local configuration. At block 138 a local report is generated as defined by the BLRE 46.

At block 116 the BLRE 46 provides context and data transformation information to apply the appropriate metrics to the reports. The storage configuration information defines how the numeric representations should be interpreted and displayed with the text equivalent. This information is provided to the reports block 140.

Accordingly while this invention has been described with reference to illustrative embodiments, this description is not intended to be construed in a limiting sense. Various modifications of the illustrative embodiment will be apparent to those skilled in the art upon reference to this description. It is therefore contemplated that appended claims will cover any such modifications or embodiments as fall within the scope of the invention.

What is claimed is:

1. An inventory management and tracking system for tracking items with RFID tags, comprising:
(a) a business logic rules engine having a plurality of rules which dictate how information is assembled and presented, provides specific dataset definitions which govern import and export of data to disparate systems, and provides an interface to planning applications as well as high end inventory, management and accounting systems;
(b) a data storage module coupled to said business logic rules engine;
(c) a capture module operative to capture information from said RFID tags;
(d) a reporting module operative to determine and produce an accurate inventory of said items; and
(e) a data transformation interface coupling said business logic rules engine to said data storage, capture and reporting modules.

2. A system according to claim 1, wherein said business logic rules engine is replaceable.

3. A system according to claim 1, wherein said capture module has multiple types of capture software.

4. A system according to claim 1, wherein said data storage module is operative to separate data and provide string to numeric abstraction, and fourth level database normalization to provide integer representation of string values.

5. A system according to claim 1, wherein said data transformation interface has a document type definition which is custom for each customer and which shapes datasets and governs the import and export of data in an appropriate format.

6. A system according to claim 1, wherein said business logic rules engine configures RFID tags and RFID tag readers and determines rules which govern transfer of information from said RFID tag readers to said data storage module.

7. A system according to claim 6, wherein scanned data sent to said system is tag ID and location ID.

8. A system according to claim 1, wherein only interpreted data is stored in said reporting module to provide pre-configured interpretation of integers, which make up a dataset.

9. A system according to claim 1, including an alternative data storage site to which non-real time data is exported from said data storage module to carry out advanced analysis.

10. A system according to claim 1, wherein new information requirements are met by adding new tables and associating them with an appropriate dataset without altering existing data structures.

11. A system according to claim 1, wherein said business logic rules engine is replaceable by installing a new component.

12. A system according to claim 1, wherein said business logic rules engine manages uncommon, proprietary and/or unique datasets required to implement said system for any business.

13. A system according to claim 1, wherein said business logic rules engine provides specific dataset definitions which map to said storage module and govern import and export of data to disparate systems.

14. A system according to claim 1, including an administration module operative to dynamically view and configure an entire network of RFID-related devices, including distribution of new business logic and array and capture configurations.

15. A system according to claim 1, wherein said storage module has a data abstraction module which stores data in concise numeric format for enhanced data handling performance.

16. A system according to claim 1, including a capture configuration agent having an input coupled to said business logic rules engine and an output coupled to said capture software providing authentication for persons using said system and specification of a depth of information that those persons are able to access.

17. A system according to claim 1, including a capture configuration agent having an input coupled to said business logic rules engine and an output coupled to said capture software providing field report configuration to view data as it arrives, to verify it and make manual changes to it.

18. A system according to claim 1, including a capture configuration agent having an input coupled to said business logic rules engine and an output coupled to said capture software providing location codes associated with a target remote system and secondary information which provides potential sub-locations.

19. A system according to claim 1, including a capture configuration agent having an input coupled to said business logic rules engine and an output coupled to said capture software providing an exact format of data to be used when transmitting data up to said system.

20. A system according to claim 1, including a storage configuration agent having an input coupled to said business logic rules engine and an output coupled to said server providing a structural hierarchy which determines a complete authentication structure that governs all access to data.

21. A system according to claim 1, including a storage configuration agent having an input coupled to said business logic rules engine and an output coupled to said server providing a table structure for interpreting end data and making associations to ultimately reconstruct data for reporting purposes.

22. A system according to claim 21, including a storage configuration agent having an input coupled to said business logic rules engine and an output coupled to the lookup tables derived from the table structure representing individual lookups required to interpret specific data.

23. A system according to claim 1, including a reporting configuration agent having an input coupled to said business logic rules engine and an output coupled to said reporting module providing authentication of users.

24. A system according to claim 1, including a reporting configuration agent having an input coupled to said business logic rules engine and an output coupled to said reporting module providing in-depth analysis reports.

25. A system according to claim 1, including a reporting configuration agent having an input coupled to said business logic rules engine and an output coupled to said reporting module providing lookup tables to interpret numeric representations in the reports.

26. A system according to claim 1, including a reporting configuration agent having an input coupled to said business logic rules engine and an output coupled to said reporting module providing an exact format of data to be used when transmitting data from said system.

27. A system according to claim 26, wherein said reporting configuration agent has a translation module to convert data into XML and other known formats.

28. A system according to claim 1, wherein said reporting module has location modeling which takes stored data and performs comprehensive analysis guided by said business logic rules engine to produce an accurate inventory of all tagged items.

29. A system according to claim 1, wherein said reporting module has item trend analysis which performs analysis on items reaching their maximum return on investment.

30. A system according to claim 1, wherein said reporting module has item trend analysis location modeling which takes stored data and performs comprehensive analysis guided by said business logic rules engine to produce an accurate inventory of all tagged items.

31. A system according to claim 1, wherein said reporting module has notification which draws settings from said business logic rules engine and selectively produce customized notifications to email, facsimile, cellphones and pagers takes stored data and performs comprehensive analysis guided by said business logic rules engine to produce an accurate inventory of all tagged items.

32. A system according to claim 1, wherein said notification has escalate action alarms which draw attention to events either happening, or not happening according to criteria set in said business logic rules engine with an alarm process that escalates through multiple notification methods.

33. A system according to claim 1, wherein said reporting module item measurement verification which takes stored data and performs comprehensive analysis guided by said business logic rules engine to produce an accurate inventory of all tagged items.

34. A system according to claim 1, wherein said reporting module has customized report metrics which provide means to configure custom reports.

35. A system according to claim 1, wherein said capture software has gateway capture software for supporting stationary sensor arrays.

36. A system according to claim 1, wherein said capture module has supports sensor arrays mounted on a front of a truck.

37. A system according to claim 1, wherein said capture module has area/yard capture software has initial tag configuration software which accepts parameters from the system and encode it to the RFID tag on the item. which takes stored data and performs comprehensive analysis guided by said business logic rules engine to produce an accurate inventory of all tagged items.

38. A system according to claim 1, wherein said capture model defines information exchange among different components.
